(19) United States
(12) Patent Application Publication
(10) Pub. No.: US 2019/0377592 A1
(43) Pub. Date: Dec. 12, 2019

(54) SYSTEM AND METHOD FOR PROVISIONING DEVICES OF A DECENTRALIZED CLOUD

(71) Applicant: VMWARE, INC., Palo Alto, CA (US)

(72) Inventors: Shubham Verma, Bangalore (IN); Ravi Kumar Reddy Kottapalli, Bangalore (IN); Kannan Balasubramanian, Bangalore (IN); Suket Gakhar, Palo Alto, CA (US); Shuhail Kadavath, Bangalore (IN); Jayakrishnan Radhakrishna Pillai, Bangalore (IN)

(21) Appl. No.: 16/120,472

(22) Filed: Sep. 4, 2018

(30) Foreign Application Priority Data
Jun. 12, 2018 (IN) 201841021937

(51) Int. Cl. G06F 9/455; G06F 9/50

(52) U.S. Cl. CPC G06F 9/45558; G06F 2009/4557; G06F 2009/45595; G06F 9/5077

(57) ABSTRACT

In a decentralized cloud computing system, a fog resource manager is utilized for management. The fog resource manager identifies nodes of the decentralized cloud computing system, and images a first one of the nodes so as to include a hypervisor. The fog resource manager further provisions one or more virtual machines on the first one of the nodes, and generates a resource pool from an inventory of the nodes. A payload is provisioned by the fog resource manager on the first one of the nodes based on a request from a virtual resource management module.

### RELATED APPLICATIONS

Benefit is claimed under 35 U.S.C. 119(a)-(d) to Foreign Application Serial No. 201841021937 filed in India entitled “SYSTEM AND METHOD FOR PROVISIONING DEVICES OF A DECENTRALIZED CLOUD”, on Jun. 12, 2018, by VMware, Inc., which is herein incorporated in its entirety by reference for all purposes.

### BACKGROUND

Fog and edge computing systems may be utilized to process data of a requester or a consumer. Further, as fog and edge computing systems are typically closer in proximity to the requester or consumer than a cloud computing system, fog and edge computing system have reduced latency cost and increased user experience as compared to that of the cloud computing system. In various implementations, one or more devices are communicatively coupled with the fog and/or edge computing systems, and the fog and/or edge computing systems are utilized to filter or pre-process data from those devices before the data is communicated to and processed by a cloud computing system or another computing device. For example, a security camera may be coupled to a network router of a fog computing system. The network router may pre-process video data received from the security camera before communicating the pre-processed video data to a cloud computing system to complete the processing of the video data.

However, while fog and edge computing system may be configured to complete simple computing tasks that reduce the amount of processing required to completed within a cloud computing system, the vast majority of complex computing tasks are required to be completed by the cloud computing system. Despite the processing power that is available within a cloud computing system, utilizing a cloud computing system may introduce unacceptable latency from when data is acquire and when the data is processed. Such latency may limit the ability of a cloud computing system from handling various time critical tasks. Further, the latency may hinder user experience.

As such, unacceptable latency may still exist, adding a delay from when the data is collected to when the data is processed.

Thus, there is a desire to further reduce the latency costs of processing data in a cloud computing system.

### SUMMARY

In one embodiment, a method for managing a decentralized cloud computing system comprises identifying, by a fog resource manager, nodes of the decentralized cloud computing system and imaging, by the fog resource manager, a first one of the nodes so as to include a hypervisor. The method further comprises provisioning, by the fog resource manager, one or more virtual machines on the first one of the nodes, generating, by the fog resource manager, a resource pool from an inventory of the nodes, and deploying, by the fog resource manager, a payload on the first one of the nodes based on a request from a virtual resource management module communicatively coupled with the fog resource manager.

In one embodiment, a computer system for managing a decentralized cloud computing system having a plurality of nodes comprises a software defined data center. The software defined data center comprises a virtual resource manager and a fog resource manager. The fog resource manager is communicatively coupled to the virtual resource manager and the plurality of nodes, and is configured to image a first one of the nodes so as to include a hypervisor, provision one or more virtual machines on the first one of the nodes, generate a resource pool from an inventory of the nodes, and deploy a payload on the first one of the nodes based on a request from the virtual resource manager.

In one embodiment, a non-transitory computer-readable storage medium contains instructions for controlling a computer processor to identify, by a fog resource manager, nodes of a decentralized cloud, image, by the fog resource manager, a first one of the nodes so as to include a hypervisor, provision, by the fog resource manager, one or more virtual machines on the first one of the nodes, generate, by the fog resource manager, a resource pool from an inventory of the nodes, and deploy, by the fog resource manager, a payload on the first one of the nodes based on a request from a virtual resource management module communicatively coupled with the fog resource manager.

### BRIEF DESCRIPTION OF THE DRAWINGS

FIGS. 1 and 2 illustrate a decentralized cloud computing system according to one or more embodiments.

FIG. 3 illustrates a software defined data center according to one or more embodiments.

FIG. 4 illustrates a node of a decentralized computing system according to one or more embodiments.

FIG. 5 illustrates a method for managing a decentralized cloud computing system according to one or more embodiments.

FIG. 6 illustrates a decentralized cloud computing system according to one or more devices.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Fog and edge computing systems may be used to form a decentralized cloud computing system. Further, data processing, data storage, and applications may be distributed amongst the fog and edge computing devices to reduce that amount of data that is required to be processed within a cloud computing system. Thus, fog and edge computing systems extend cloud computing and services to be closer in proximity to where the data is acquired and acted upon. In various embodiments, by offloading at least a portion of the computing tasks to the fog and edge computing systems, the efficiency may be approved and the amount of data that is communicated to a cloud computing system for processing is reduced.

Fog and edge computing systems place increased computing resources and application services closer to the data sources, and may function in space between the data sources and a cloud computing system. Further, by integrating the fog and edge computing system with Software Defined Data Center (SDDC), fog and edge computing systems may be configured to implement virtual machines (VMs) to increase the computing capabilities of the fog and edge computing systems. Further, the VMs running on the fog and edge devices may be process data, and return the processed data to the data source or determine an action to be taken based on the process data without interaction from a cloud computing system. In one particular embodiment, data received from a video camera may be processed by a VM running on a network router to identify one or more target objects, and the network router may be configured to complete a final action based on the identified objects. In such an embodiment, processing of the data and determining a final action may occur within in close proximity to the data source, reducing latency of both processing the data and determining and/or executing a final action.

Fog and edge computing systems may include smart computing systems (e.g., smart grid, smart city, and smart buildings), vehicle networks, and software-defined networks. Further, network switches, routers and gateways, Internet of things (IoT) capable devices, accelerators, network connected computing devices and other network connected devices may be included within and implemented by the fog and edge computing systems. Further, as the use of IoT devices increases, VMs implanted within fog and edge computing systems may be used to process acquired data. In such an implementation, in addition to reduced latency as is described above, the cost of IoT devices may be reduced as complex processing may be offloaded to a fog and edge computing system, reducing the computer processing requirements of the IoT devices.

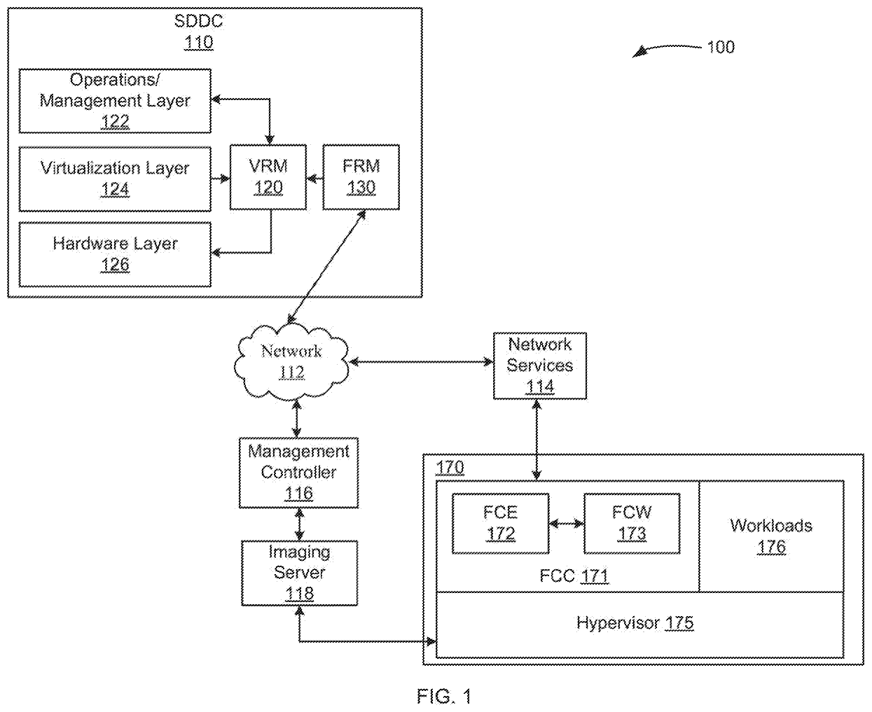

FIG. 1 illustrates a decentralized cloud computing system 100 according to one or more embodiments. In the illustrated embodiment, the decentralized cloud computing system 100 includes software defined data center (SDDC) 110, and decentralized server node 170. The decentralized cloud computing system 100 is communicatively coupled to decentralized server node 170 via network 112. In one embodiment, network services 114 control the flow of communication between the network 112 and decentralized server node 170. Further, a management controller 116 and imaging server 118 for an out of band management network and is communicatively coupled between network 112 and hypervisor 175.

SDDC 110 includes virtual resource manager (VRM) 120, fog resource manager (FRM) 130, operations/management layer 122, virtualization layer 124, and hardware layer 126. VRM 120 is communicatively coupled between FRM 130 and operations/management layer 122, virtualization layer 114, and hardware layer 126.

In various embodiments, SDDC 110 includes software platform executing on a hardware platform. The hardware platform may include conventional components of a computing device, such as a central processing unit (CPU), system memory (“memory”), storage, input/output (IO) devices, a nonvolatile memory (NVM). The CPU is configured to execute instructions, for example, executable instructions that perform one or more operations described herein and may be stored in a memory and/or storage. Memory is a device allowing information, such as executable instructions, virtual disks, configurations, and other data, to be stored and retrieved. Memory may include, for example, one or more random access memory (RAM) modules. Storage includes local storage devices (e.g., one or more hard disks, flash memory modules, solid state disks, and optical disks) and/or a storage interface that enables SDDC 110 to communicate with one or more network data storage systems. Examples of a storage interface are a host bus adapter (HBA) that couples SDDC 110 to one or more storage arrays, such as a storage area network (SAN) or a network-attached storage (NAS), as well as other network data storage systems. IO devices include conventional interfaces known in the art, such as one or more network interfaces, serial interfaces, universal serial bus (USB) interfaces, and the like. NVM is a device allowing information to be stored persistently regardless of the state of power applied to computing system 100 (e.g., FLASH memory or the like). NVM may store firmware for SDDC 110, such as a Basic Input/Output System (BIOS), Unified Extensible Firmware Interface (UEFI), or the like.

Operations/management layer 122 comprises one or more software elements configured for cloud management. In one embodiment, the operations/management layer 122 manages the infrastructure and application and provides real time analysis, automated costing, usage metering and service pricing for virtualized infrastructure.

Virtualization layer 124 includes cloud management elements that are configured to manage software-based virtual machines (VMs). For example, the virtualization layer 124 may be configured to create, snapshot, delete and restore VMs. In one or more embodiments, virtualization layer 124 includes a management plane of a virtual network, such as the NSX Manager product that is commercially available from VMware, Inc. Virtualization layer 124 may also include a virtual machine (VM) manager, such as the vSphere® product that is commercially available from VMware, Inc.

The network virtualization implements at least one of a management plane, a control plane, and a data plane. The management plane allows the platform to process large-scale concurrent API requests from a cloud layer. A control plane keeps track of the real-time virtual networking and security state of the system. In one embodiment, the control plane may be split into two parts, a central control plane (CCP) and a local control plane (LCP). The LCP runs on the compute endpoints, which are known as transport nodes. In one or more embodiments, data plane includes a host switch, which enables the overlay network, as well as traditional VLAN-based topology.

Hardware layer 126 may include a hardware management services (HMS) that is configured to manage the hardware of SDDC 110. For example, the hardware layer 126 may be configured to manage hardware elements such as hosts and network switches. Further, hardware layer 126 may be configured to discover, bootstrap, and/or monitor the hardware. Further, the hardware layer 126 may be configured to access hosts and switches on the out-of-band network.

VRM 120 communicatively couples FRM 130 to operations/management layer 122, virtualization layer 124, and hardware layer 126. VRM 120 may be configured to manage resource allocation and resource management concepts, VM attributes and admission control, resource pools, datastore clusters, advanced resource management options, and performance considerations.

FRM 130 is communicatively coupled to decentralized server node 170 via network 112. In one embodiment, FRM 130 is coupled to fog sever node 170 via an in-band network and an out-of-band network. The in-band network includes network 112 and network services 114, and the out-of-band network includes network 112, management controller 116 and imaging server 118. FRM 130 performs the functions of managing, scheduling, and orchestrating of the FCEs from within the hosting site on the data center (e.g., SDDC 110). Further, the FCEs perform the functions of a micro-data center manager within the hosting site (e.g., decentralized server node 170).

Network services 112 may include a gateway configured to manage external public IP address and/or route incoming to and going from SDDC 110 and/or decentralized server node 170, and provide networking services, such as firewalls, network address translation (NAT), dynamic host configuration protocol (DHCP), and load balancing.

Network 112 may be a direct link, a LAN, a wide area network (WAN) such as the Internet, another type of network, or a combination of these.

Decentralized sever node 170 includes fog computing components (FCC) 171, hypervisor 175 and workloads 176. The decentralized server node 170 may be alternatively referred to as a fog server node or an edge server node. The FCC may additionally or alternatively include edge computing components. In one embodiment, FCC includes fog computing engine (FCE) 172 and fog computing worker (FCW) 173. Further, while a single FCC is shown, in one or more embodiments, multiple FCCs concurrently run on decentralized server node 170. In one embodiment, an operating system (OS) may run on hypervisor 175. The OS may be a Linux based operating system, such as Photon OS.

Decentralized server node 170 is a node of a fog and/or edge layer that can include any device with computing, storage, and network capabilities. For example, a decentralized server node may be one of a network router, network switch, accelerator, micro-processor, access node, gateway, remote office branch office (ROBO) site, wide-area-network (WAN) device and software-defined network-area-network (SD-WAN) device. Further, the a fog sever node may be a personal computing device, hand held computing device, industrial controller, embedded server, video surveillance camera, a sensor module within an electronic system, an internet of things device, and the like. Further, in various embodiments, the fog layer may include edge computing devices, which include computing devices are at the edge of the network, near the source of the data. Decentralized server nodes of the fog layer may each have different configurations, and different hardware capabilities.

In one embodiment, a decentralized computing system may be configured to allocate hardware and/or software resources to individual devices communicatively coupled within the decentralized computing system.

Hypervisor 175 manages the hardware of decentralized server node 170 to properly allocate computing resources for FCC 171. For example, hypervisor 175 abstracts processor, memory, storage, and networking resources of decentralized server node 170 into one or more VMs, illustrated as FCC 171. Hypervisor 175 on the hardware of decentralized server node 170. One example of a hypervisor that may be used is a VMware ESXi™ hypervisor provided as part of the VMware vSphere® solution made commercially available from VMware, Inc. of Palo Alto, Calif. Further, hypervisor 175 is configured to interact with OS 174.

In various embodiments, hypervisor 175 is an intermediate agent between the query for the CPU feature set of decentralized server node 170 and the response by a physical CPU. Further, hypervisor 175 may be configured to modify the response of the CPU before passing the feature set on to FCC 171.

FCC 171 includes fog computing engine (FCE) 172 and fog computing worker (FCW) 173. FCE 172 is a VM running on hypervisor 175 and provides a management interface, local management user interface, application life cycle management, statistical analysis, backup and restore, billing and metering, and management stack services. Further, FCW 173 is configured to host the container or function workloads. In one embodiment, FCW 173 is communicated coupled to a container orchestrator, which is configured to supervise and monitor FCW 173. In one embodiment, FCW 173 is a separate set of virtual machines as part of the workload domain, separating the management and control plane from the workload plane of the corresponding VMs. The container may include a container as a service (CaaS), and functions may include (FaaS). Both CaaS and FaaS may be referred to as the payload.

Workloads 176 include one or more workloads running on the decentralized server node 170 that is separate from FCC 171. In embodiments where the decentralized server node 170 is a network device, the workloads may include one or more network functions, such as routing, switching, or the like. In other embodiments, where the decentralized server node 170 corresponds to other devices, the workloads may include other functions.

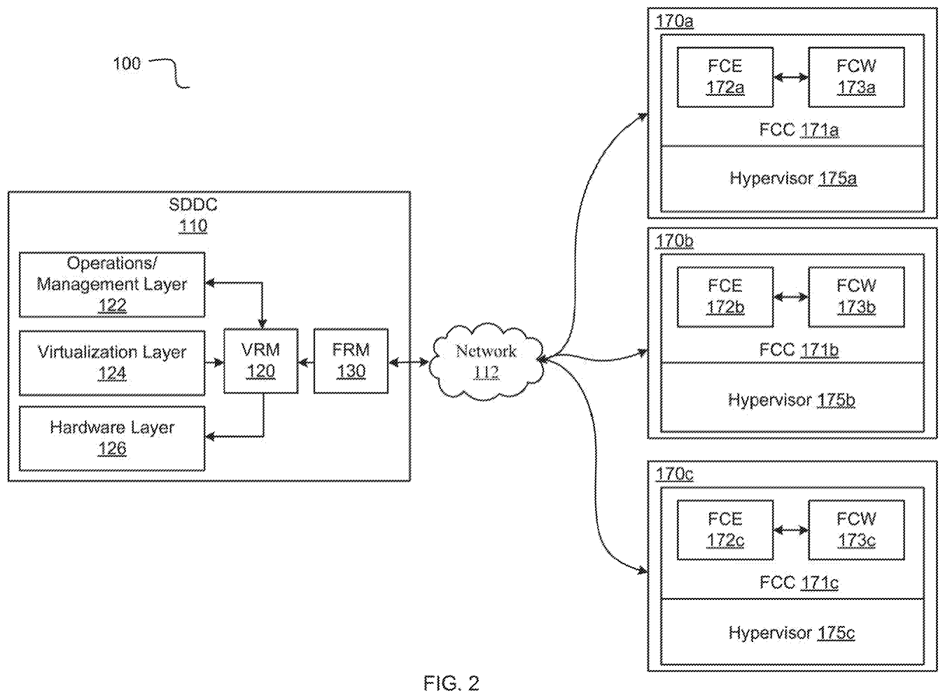

FIG. 2 illustrates SDDC 110 coupled to decentralized server nodes 170a-170c via network 112. Each of decentralized server nodes 170a-170c corresponds to a different type of computing device of a decentralized computing system. The decentralized computing system may be one of a fog layer and/or an edge layer. In one embodiment, decentralized server nodes 170a-170c may include different computing devices of a common electronic system. In various embodiments, decentralized server nodes 170a-170c may have different capabilities. Further, while a single FCE is illustrated as running on each corresponding hypervisor, one or more of decentralized server nodes 170a-170c may have multiple FCE instances running on the corresponding hypervisor.

As is illustrated in FIG. 2, FCC 171a and FCW 173a are implemented on hypervisor 175a, FCC 171b and FCW 173a are implemented on hypervisor 175b, and FCC 171c and FCW 173a are implemented on hypervisor 175c. Further, while not illustrated an operating system may run on top of each hypervisor 175, and each FCC 171 may run on each corresponding OS.

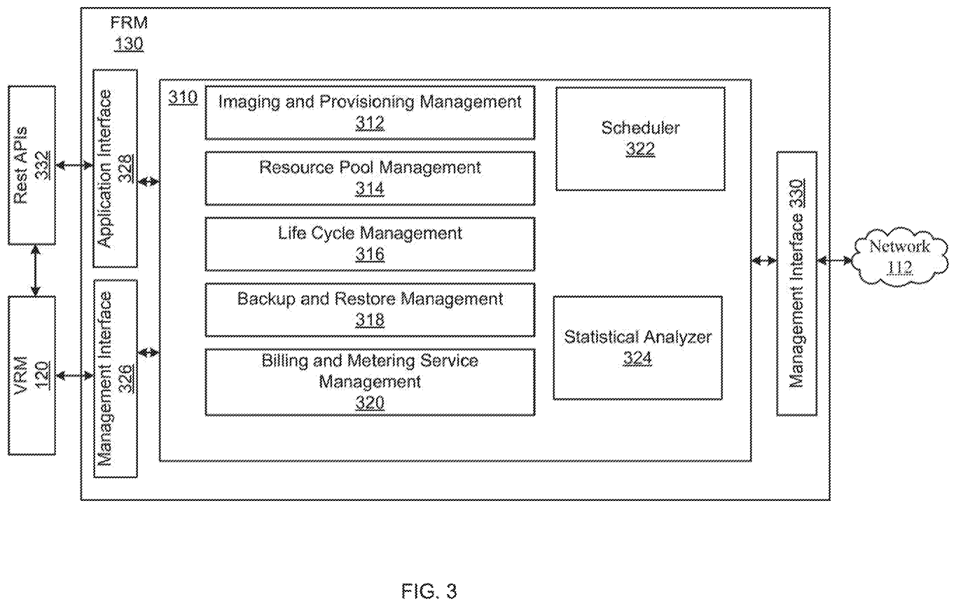

FIG. 3 illustrates the services and responsibilities 310 of FRM 130. As illustrated FRM 130 includes services imaging and provisioning management 312, resource pool management 314, life cycle management 316, back and restore management 318, billing and metering service management 320, scheduler 322, and statistical analyzer 324. Further, FRM 130 includes management interface 330 that is communicatively coupled to network 112, management interface 326 that is communicatively coupled to VRM 120, and application interface 328 that is communicatively coupled to REST APIs 332.

Imaging and provisioning management 312 includes services responsible for remote imaging of the decentralized server node (e.g., decentralized server node 170) with a corresponding hypervisor (e.g., hypervisor 175), and upgrading or patching decentralized server nodes.

In various embodiments, FRM 130 communicates with imaging server 118 via network 112 and management controller 116 (the out-of-band management network) to image hypervisor 175. In one embodiment, image server 118 receives commands from FRM 130 to load the image onto the local datastore of the decentralized server node 170. Further, FRM 130 communicates with decentralized server node 170 via network 112 and network services 114 to upgrade or patch the decentralized server node 170 and image the FCC 171 components. FRM 130 sends updated and/or patch commands to decentralized server node 170 via network 112 and network services 114.

FRM 130 is further configured to image each decentralized server node 170 with FCE 172 and/or FCW 173.

Resource pool management 314 is configured to create different resource pools and maintain a registry of different resource quota allocations for the corresponding resource pools. For example, the resource pools may include normal compute pools and high performance compute pools. The normal compute pools correspond to hosting regular payloads, and the high performance compute pools correspond to payloads requiring high performance computing and/or graphic processing enabled decentralized server nodes. In other embodiment, other compute pools may be created. In one or more embodiments, compute pools may be created corresponding to other features of the decentralized server nodes. For example, compute pools may be created for devices having camera features or other sensing features.

Life cycle management 316 manages the life cycles of FRM services, and payload life cycles. For example, life cycle management 316 is configured to fetch, deploy, execute, debug and upgrade payloads. In one embodiment, life cycle management 316 fetches a container or a function payload and request scheduler 322 to deploy payload to available decentralized server nodes. In one embodiment, fetching a payload may include migrating an existing container or serverless function from SDDC 110 to a decentralized server node. Scheduler 322 forwards the payload to a respective FCE 172 and notices life cycle management 316 regarding the success or failure of deployment of the payload on a respective FCE. Life cycle management 316 is further configured to note the deployment of the payload, and if necessary, persists it, and notifies an administrator regarding the result of deployment. Life cycle management 316 is further configured to, if requested; send commands to the respective FCE to execute the payload. In one embodiment, if an administrator provides an IP of an already hosted container on a workload of SDDC 110, the life cycle management 316 requests the scheduler 322 to identify an available free decentralized server node and provides commands to migrate the container from the data center to the free fog server.

In one embodiment, life cycle management 316 may be configured to receive an indication from statistical analyzer 324 that a particular decentralized server node is overburdened due to a particular payload. In response, the life cycle management 316 may be configured to request that the overburdened decentralized server node terminate the payload and contact scheduler 322 to reschedule the payload onto another decentralized server node.

In another embodiment, life cycle management 316 is configured to migrate existing containers from the SDDC 110 to a decentralized server node (decentralized server node 170). The FRM 130 receives a REST call indicating the target and the container ID to migrate. Life cycle management 316 communicates with FCE 172 to collect information related to the FCE 172. For example, the life cycle management 316 receives information regarding the configuration and image location of the FCE 172. Further the life cycle management 316 deploys the container to the decentralized server node 170, communicates with the SDDC 110 to stop container within the SDDC 110, and obtains status information regarding the container.

Scheduler 322 is configured to track each of the decentralized server nodes present in the resource pool, and the corresponding payloads deployed on each of the decentralized server nodes. Further, the scheduler 322 communicates with the statistical analyzer 324 to obtain performance metrics of the payloads deployed on each decentralized server node. Further, in one or more embodiments, the scheduler 322 is configured to calculate a probability of which decentralized server node with be the best choice to deploy a selected payload. The calculated payload may be based on metadata provided by an administrator. The metadata may include one or more of a preferred location of the decentralized server node, type of payload, affinity of the payload, approximate execution time of payload, and synchronous/asynchronous behavior of the payload.

Statistical analyzer 324 is configured to pull different decentralized server nodes periodically to determine the performance and health metrics for each of the decentralized server nodes, and the services managed by the FCEs. Further, the statistical analyzer 324 may be configured to store the statistics for further analysis. For example, scheduler 322 and/or life cycle management 316 may be configured to perform analysis of the statistics stored by the statistical analyzer 324. In one embodiment, the statistical analyzer 324 receives a “heartbeat” from each FCE (e.g., FCE 172a, 172b, and/or 172c), and persists the “heartbeat” information within a “heartbeat” file. The “heartbeat” is indication of the availability of the decentralized server nodes.

Further, in various embodiments, the statistical analyzer 324 receives hardware management events from respective FCEs, collected by the corresponding hypervisors. The hardware management events comprise one or more of changes to the amount of RAM upgrades, the size of the hard drive, the type of data-store, the type of and/or capabilities of a graphic processor unit (GPU), and the type of and/or capabilities of the central processor or processors.

Backup and restore management 318 is configured to perform periodic backups, scheduled backups and/or event triggered backups of the FCE. Further, Backup and restore management 318 is configured to restore (migrate) a payload deployed on a decentralized server node that is no longer correctly functioning on an available decentralized server node. For example, when a decentralized server node fails, that statistical analyzer 324 notifies the life cycle management 316 via a failure alarm. The life cycle management 316 queries backup and restore management 320 to obtain the payloads details (e.g., container or function metadata) with regard to the failed decentralized server node. Further, the life cycle management 316 contacts the scheduler 322 to redeploy the same payload on one or more available decentralized server nodes.

Billing and metering service management 320 is linked to the revenue generation of the fog service provider and is configured to acquire information and/or metric from the billing and metering service on individual decentralized server nodes (e.g., billing and metering service 420 of decentralized server node 170. In one embodiment, the information may be based on different parameters, for example, the number of payload instances deployed, execution time, storage for container/function assets on the decentralized server nodes.

Management interface 326 manages the communication between FRM 130 and VRM 120. Further, application interface 328 is configured to acquire REST APIs from REST APIs 332.

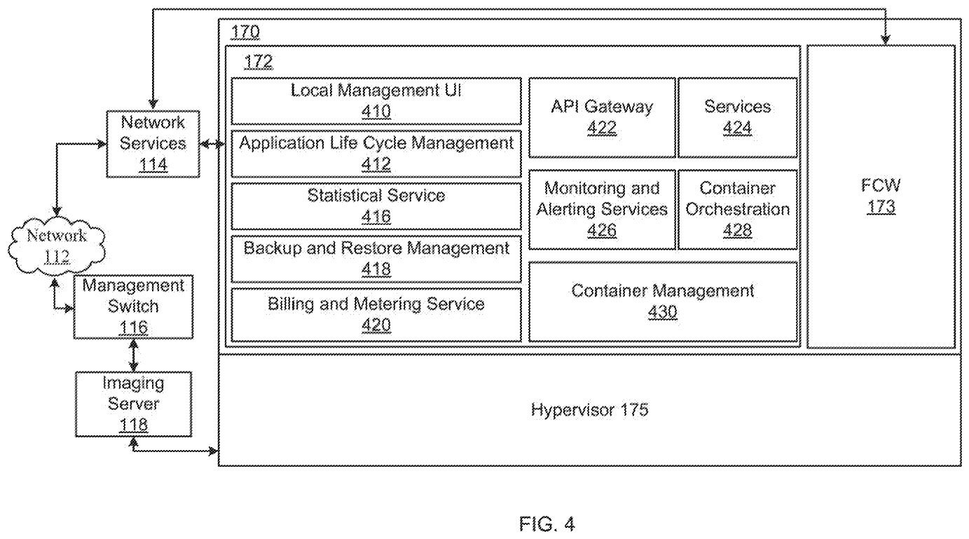

FIG. 4 illustrates decentralized server node 170. In one embodiment, the decentralized server node 170 includes FCE 172, FCW 173, and hypervisor 175. Further, decentralized server node 170 may additionally include an OS running on top of hypervisor 175. As illustrated in FIG. 4, FCE 172 includes services local management UI 410, application life cycle management 412, statistical service 416, backup and restore management 418, and billing and metering service 420. Further, FCE 172 includes API gateway 422, services 424, monitoring and alerting services 426, container 428 and container management 430. In one embodiment, decentralized server node 170 includes a management interface configured to receive REST request from the FRM 130 and communicates the REST requests to the different services within FRM 130. In one embodiment, the management interface is included within network services 114.

Local management UI 410 is the frontend configured to provide administrative access to different services of FCE 172 and decentralized server node 170. Local management UI 410 may be used by user administrators to access decentralized server node 170. For example, a user administrator may access decentralized server node 170 via the local management UI 420 when the connection between FRM and decentralized server node 170 fails. Further, a user administrator may access decentralized server node 170 via the local management UI 420 to perform maintenance of the decentralized server node 170.

Application life cycle management 412 is the counterpart to life cycle management 316 of FRM 130. In one embodiment, the life cycle management 316 is configured to perform life cycle services of FCE 172 and the payload provided by the FRM 130. Further, life cycle management 316 is configured to communicate failures to statistical service 416. In various embodiments, the application life cycle management 412 is configured to communicate with container management 430 to obtain information on stages and/or status of payload deployment, execution and failure.

Statistical service 416 is configured to collect statistical information and communicate the statistical information to FRM 130. The statistical information includes events, alerts, and/or performance related statistics. Statistical service 416 may periodically communicate the statistical information to FRM 130, communicate the statistical information in response to a request from FRM 130, or communicate the statistical information in response to an event. Further, the statistical service 416 is configured communicate the “heartbeat” of the fog server 170 to the FRM 130. The “heartbeat” is an indication that the decentralized server node is available.

Backup and restore management 418 is configured to backup the configuration of FCE 172. Further, the backup and restore management 418 may be configured to receive events from statistical service 416. The events may be one or more of an event from application life cycle management 412, events from hypervisor 175, events from container management 430, events from monitoring and alerting services 426, software upgrades received via local management UI 410, password changes received via local management UI 410, and events from the FRM 130. Events from FRM 130 may include imminent upgrades, failure predictions, and/or failures to echo the “heartbeat” to the FRM 130 within a time duration threshold.

Billing and metering services 420 may be configured to complete the billing and metering responsibilities and forward the same to the billing and metering service management 320.

Container management 430 may be an OS-level virtualization provider. For example, container management 430 may be a Docker daemon, or another Linux daemon. Further, the container management 430 is a computer program that runs as a background process and may be started when the decentralized server node is booted. In one embodiment, container management 430 implements a high-level API to provide one or more containers. Container Orchestration 428 is configured to control and service containers running on decentralized server node 170. Further, API gateway is configured to management traffic into and out of decentralized server node 170. Services 424 include cloud computing services. For example, services 424 may include function as a service (FAAS). Further, monitoring and alerting services 426 are configured to monitor containers running within decentralized server node 170 and provide an alert when the container fails.

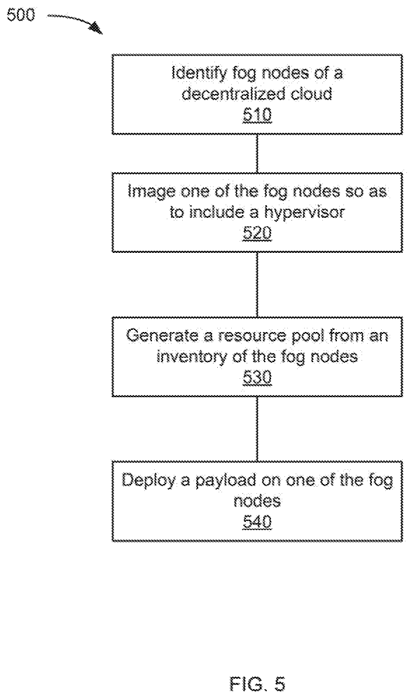

FIG. 5 illustrates a method 500 for managing a decentralized cloud computing system. For example, method 500 used to manage a decentralized cloud comprising decentralized server nodes 170a-170c. At step 510 of method 500 a first one of the decentralized server nodes of the decentralized cloud computing system are identified. In one embodiment, FRM 130 is configured to identify the decentralized server nodes within the decentralized nodes.

At step 520, a decentralized server node is imaged so as to include a hypervisor. For example, the FRM 130 may be configured to image the decentralized server node 170 so as to include the hypervisor. In one embodiment, FRM 130 communicates commands to decentralized server node 170 over an out-of-band network connect (e.g., via network 112, management switch 116 and imaging server 118). FRM 130 may provide commands (e.g. instructions) to imaging server 118, instructing imaging server 118 to image decentralized server node 170 so as to include the hypervisor (e.g., hypervisor 175).

At step 530 of method 500 a resource pool from an inventory of the decentralized server nodes is generated. FRM 130 may communicate with each of decentralized server node within the decentralized cloud to determine one or more of the IP details, out-of-band management, name of call node, unique identifier for each node, capabilities of the node, and/or storage resources for the node. A decentralized computing system may include any number of server nodes. For example, the number of server nodes may be about a 1000 or more. Further, SDDC 110 may be configured to create an inventory that includes both cloud computing resources and decentralized cloud computing resources. In another embodiment, SDDC 110 may be configured to create a first inventory cloud computing resources and a second cloud for decentralized cloud computing resources.

In one or more embodiment, FRM 130 may be configured to generate different pools based on different resource quota, each of the pools having different parameters. For example, a first pool may be created to include decentralized server nodes having high performance computing capabilities and a second pool may be created that has standard performance computing capabilities. Further, a pool may be created to include decentralized server nodes having GPUs. In other embodiments, any number of pools may be created based on any combination of resources of the decentralized server nodes.

In various embodiments, FRM 130 may provide instructions to bring up the decentralized server nodes. For example, FRM 130 may provide instructions to provision one or more VMs and initialize an operating system, and/or an FCC within each of the decentralized server nodes and initialize the services of the VMs. The services may include management components within the VM. After the VM is initialized and the services of started, FRM 130 may be configured to update the inventory. In one embodiment, FRM 130 is configured to upgrade patch decentralized server node 170.

At step 540 of method 500 a payload is deployed within the fog nodes. In one embodiment, FRM 130 may provide instructions to deploy the payload. In one embodiment, life cycle management 316 is configured to communicate with application life cycle management 412 to deploy a payload on decentralized server node 170. The payload may be deployed by life cycle management 316 of FRM 130 in response to instructions provided by VRM 120. In one embodiment, deploying the payload comprises fetching the payload based on a request from the VRM 120, and provisioning the payload on a decentralized server node.

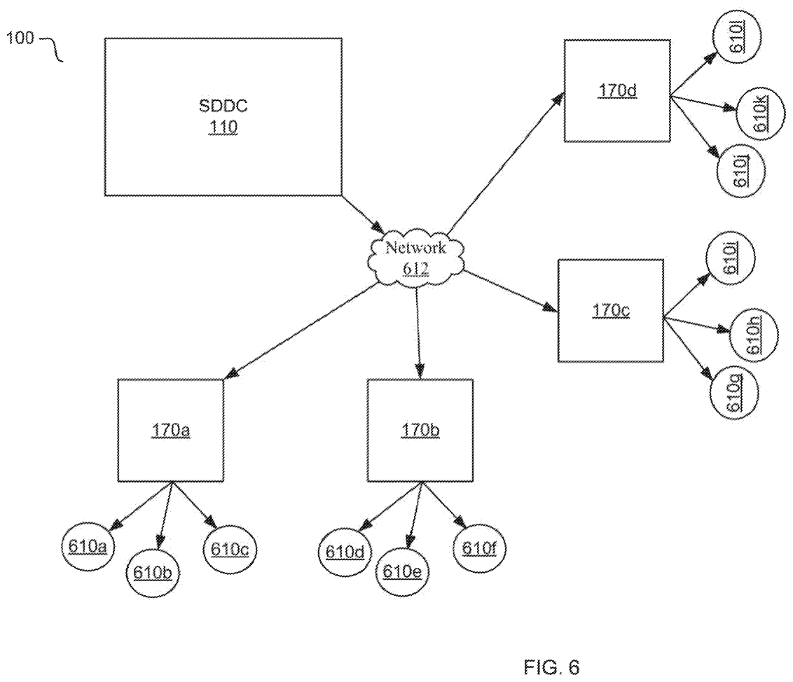

FIG. 6 illustrates a decentralized cloud computing system 100 comprising SDDC 110, decentralized server nodes 170a-170d, and devices 610a-6101 communicatively coupled via network 612. Network 612 may be configured similar to network 112. Further, network connected devices 610a-6101 may be network connected devices such as cameras, sensing devices, personal computing devices, and the like. Further, while each decentralized server node 170a-170d is illustrated as being communicatively coupled to three network connected devices, in other embodiments, each decentralized server node may be communicatively coupled to any number of network connected devices. For example, the decentralized server nodes 170a-170d may be coupled to less than three network connected devices or more than three network connected devices. Further, one or more of devices 610a-6101 may be communicatively coupled to more than one fog sever node. In one embodiment, computing resources utilized to process data provided by one or more of network connected devices 610a-6101 may be offloaded to one or more decentralized server nodes 170a-170d.

In one embodiment, one or more of the devices 610a-6101 may be a video camera configured to stream video data to be used for plate recognition at one or more locations. As the volume and velocity of the data provided by the video data, the computing resources required to perform the plate recognition is high. FRM 130 of SDDC 110 may receive a request from an administrator user to deploy a plate recognition service on a particular decentralized sever node or nodes, and deploys the plate recognition service to one or more respective decentralized server node or nodes. The video data streamed by the one or cameras is communicated to the decentralized server node or nodes running the plate recognition service for processing. For example, the plate recognition service may be configured to perform pre-processing and machine learning on the video data, and communicate analytics data to a cloud computing service. For example, the plate recognition service may be configured to identify suspicious objects, vehicles, crowd density or the like to the cloud computing service. In one embodiment, FRM 130 may be configured to update machine learning models utilized by the plate recognition service.

Further, offloading processing of the video data to the decentralized server nodes may reduce latencies as compared to processing the video data within a cloud computing system as the connection between the decentralized server nodes and the network connected devices is faster than the connection between network connected devices and the cloud computing system. This is due to the proximity between the network connected devices and the decentralized server nodes as compared to the proximity between the network connected devices and the cloud computing system, and the network connected devices are communicatively coupled to the cloud computing system via the decentralized server nodes.

In other embodiments, other services requiring low latency may be offloaded to decentralized server nodes 170a-170d. Further, services that require continuous connection to a cloud computing system may also be offload to the fog sever nodes 170a-170d to reduce the possibility that the connection between the network connected device and the node processing the data is dropped, as the connection between the network connected device and a decentralized server node may be more stable than a connection between the network connected device and the cloud computing system.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) -CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for managing a decentralized cloud computing system, the method comprising:
identifying, by a fog resource manager, nodes of the decentralized cloud computing system;
imaging, by the fog resource manager, a first one of the nodes so as to include a hypervisor;
provisioning, by the fog resource manager, one or more virtual machines on the first one of the nodes;
generating, by the fog resource manager, a resource pool from an inventory of the nodes; and
deploying, by the fog resource manager, a payload on the first one of the nodes based on a request from a virtual resource management module communicatively coupled with the fog resource manager.

2. The method of claim 1, wherein imaging the first one of the nodes so as to include a hypervisor comprises communicating commands from the fog resource manager to the first one of the nodes over an out of band management network.

3. The method of claim 1, wherein provisioning the one or more virtual machines on the first one of the nodes comprises initializing one or more services and an operating system on the first one of the nodes.

4. The method of claim 1, wherein generating the resource pool from an inventory of the nodes comprises generating at least two different pools having different parameters.

5. The method of claim 1, wherein deploying the payload on the first one of the nodes comprises: fetching a payload based on a request from the virtual resource management module; and provisioning the payload on the first one of the nodes, wherein the payload comprises one of a function and a container.

6. The method of claim 1 further comprising:
upgrading, by the fog resource manager, the first one of the nodes; and
generating, by the fog resource manager, the inventory.

7. The method of claim 1, wherein the fog resource manager is located within a software defined data center and is communicatively coupled each of the nodes via a network, the software defined data center comprises the virtual resource management module and a virtualization manager.

8. A computer system for managing a decentralized cloud computing system having a plurality of nodes, the computer system comprising:
a software defined data center comprising:
virtual resource manager; and
a fog resource manager communicatively coupled to the virtual resource manager and the plurality of nodes, the fog resource manager is configured to:
image a first one of the nodes so as to include a hypervisor;
provision one or more virtual machines on the first one of the nodes;
generate a resource pool from an inventory of the nodes; and
deploy a payload on the first one of the nodes based on a request from the virtual resource manager.

9. The computer system of claim 8, wherein imaging the first one of the nodes so as to include a hypervisor comprises communicating commands from the fog resource manager to the first one of the nodes over an out of band management network.

10. The computer system of claim 8, wherein provisioning the one or more virtual machines on the first one of the nodes comprises initializing one or more services and an operating system on the first one of the nodes.

11. The computer system of claim 8, wherein generating the resource pool from an inventory of the nodes comprises generating at least two different pools having different parameters.

12. The computer system of claim 8, wherein deploying the payload on the first one of the nodes comprises: fetching a payload based on a request from the virtual resource management module; and provisioning the payload on the first one of the nodes, wherein the payload comprises one of a function and a container.

13. The computer system of claim 8, wherein the fog resource manager is further configured to:
upgrade the first one of the nodes; and
generate the inventory.

14. The computer system of claim 8, wherein the fog resource manager is further configured to:
image a second one of the nodes so as to include a hypervisor;
provision one or more virtual machines on the second one of the nodes; and
deploy a payload on the second one of the nodes based on a second request from the virtual resource manager.

15. A non-transitory computer-readable storage medium containing instructions for controlling a computer processor to:
identify, by a fog resource manager, nodes of a decentralized cloud computing system;
image, by the fog resource manager, a first one of the nodes so as to include a hypervisor;
provision, by the fog resource manager, one or more virtual machines on the first one of the nodes;
generate, by the fog resource manager, a resource pool from an inventory of the nodes; and
deploy, by the fog resource manager, a payload on the first one of the nodes based on a request from a virtual resource management module communicatively coupled with the fog resource manager.

16. The non-transitory computer-readable storage medium of claim 15, wherein imaging the first one of the nodes so as to include the hypervisor comprises communicating commands from the fog resource manager to the first one of the nodes over an out of band management network.

17. The non-transitory computer-readable storage medium of claim 15, wherein provisioning the one or more virtual machines on the first one of the nodes comprises initializing one or more services and an operating system on the first one of the nodes.

18. The non-transitory computer-readable storage medium of claim 15, wherein generating the resource pool from an inventory of the nodes comprises generating at least two different pools having different parameters.

19. The non-transitory computer-readable storage medium of claim 15, wherein deploying the payload on the first one of the nodes comprises: fetching a payload based on a request from the virtual resource management module; and provisioning the payload on the first one of the nodes, wherein the payload comprises one of a function and a container.

20. The non-transitory computer-readable storage medium of claim 15 further comprising:
upgrading, by the fog resource manager, the first one of the nodes; and
generating, by the fog resource manager, the inventory.
